(19) United States
(12) Patent Application Publication
(10) Pub. No.: US 2017/0195465 A1
(43) Pub. Date: Jul. 6, 2017

(54) Antenna efficiency boosting device and mobile terminal

(71) Applicants: Le Holdings (Beijing) Co., Ltd., Beijing (CN); Lemobile Information Technology (Beijing) Co., Ltd, Beijing (CN)

(72) Inventors: Huanqu HUANG, Beijing (CN); Junyi WANG, Beijing (CN); Lishan HUANG, Beijing (CN)

(21) Appl. No.: 15/241,706

(22) Filed: Aug. 19, 2016

Related U.S. Application Data
(63) Continuation of application No. PCT/CN2016/088827, filed on Jul. 6, 2016.

(30) Foreign Application Priority Data
Jan. 6, 2016 (CN) 2016100095814

(51) Int. Cl. H04M 1/02; H04M 1/60

(52) U.S. Cl. CPC H04M 1/0202; H04M 1/6041; H04W 88/04

(57) ABSTRACT

An antenna efficiency boosting device and a mobile terminal, wherein an antenna efficiency boosting device is configured for use in a mobile terminal, wherein the mobile terminal has a metallic housing, the metallic housing has at least one discontinuous position, the discontinuous position is for example a broken point, broken seam or broken slot, the antenna efficiency boosting device comprises at least one branch which is coupled to both ends of the discontinuous position and used to adjust the efficiency of the antenna of the mobile terminal.

### CROSS REFERENCE TO RELATED DISCLOSURES

This application is a continuation of International Application No. PCT/N2016/088827, filed on Jul. 6, 2016, which is based upon and claims priority to Chinese Patent Application No. 201610009581.4, filed on Jan. 6, 2016, the entire contents of which are incorporated herein by reference.

### TECHNICAL FIELD

The present disclosure relates to the technical field of antenna, and specifically to an antenna efficiency boosting device and a mobile terminal.

### BACKGROUND

A mobile terminal (e.g., a mobile phone) usually employs a housing of a plastic material such as polycarbonate PC, acrylonitrile butadiene styrene copolymers ABS, or PC+ABS. As compared with a plastic housing, the metallic housing has advantages such as firmness, good hand feeling and nice appearance. At present, more and more mobile terminals begin to use metallic housing.

However, the metallic housing exerts an influence on the signal receiving and transmitting signal of the antenna. According to antenna design technology in the prior art, the antenna, surrounded by metal or in a complete metallic frame, is not apt to perform effective radiation, so the metallic housing usually needs to be broke at proper locations in the form of broken seams to help the antenna to radiate. However, these broken seams are rather sensitive to changes of ambient environment of the antenna (e.g., when a user holds the mobile phone with a hand, or when the user puts the antenna close to his face upon making a call), finally the antenna's performance is caused to drop and affects the user's experience.

An approach in the prior art is to provide a plurality of antennas, e.g., one primary antenna and at least one secondary antenna. Software algorithm is used to implement handover of the mobile phone between the plurality of antennas. If the user holds the mobile phone with a hand and causes the performance of the in-use antenna to substantially fall, the system will control other antennas to replace the in-use antenna whose performance is deteriorating to perform reception and transmission of the signal to obtain a better communication quality. Hence, based on current common space stack, whole-machine dimensions and shape design of the mobile phone, the mobile phone usually has a primary antenna and other secondary antennas, and the primary antenna is mostly disposed in a lower portion of the mobile phone, whereas the secondary antennas are usually disposed in an upper portion or lateral portion of the mobile phone.

In other words, when the user holds the mobile phone with a hand or covers sensitive locations (namely, broken seams) of the antenna so that its performance often falls substantially in this scenario, the system will hand over to the secondary antenna.

However, upon calling, the user's head probably approaches the mobile phone to hear. The secondary antenna whose performance is not as good as the primary antenna will further deteriorate due to the approach of the head; additionally, if the secondary antenna is responsible for the transmitting and receiving function due to the handover, it usually needs to reduce the power transmitted and output by its board end due to its approach to the human body to reduce the human body's specific absorption rate SAR for electromagnetic energy. Hence, the antenna's communication quality usually substantially reduces.

### SUMMARY

In view of the above, the present disclosure proposes an antenna efficiency boosting device and a mobile terminal, capable of improving antenna efficiency.

According to an aspect of the present disclosure, there is provided an antenna efficiency boosting device for use in a mobile terminal, wherein the mobile terminal has a metallic housing, the metallic housing has at least one discontinuous position, the antenna efficiency boosting device comprises at least one branch which is coupled to both ends of a broken seam at the discontinuous position for adjusting the efficiency of the antenna of the mobile terminal.

According to another aspect of the present disclosure, there is provided a mobile terminal, wherein the mobile terminal has a metallic housing, the metallic housing has at least one discontinuous position, the mobile terminal further comprise: an antenna and an antenna efficiency boosting device; the antenna efficiency boosting device comprises at least one branch which is coupled to both ends of the discontinuous position for adjusting the efficiency of the antenna of the mobile terminal.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 illustrates a left view of a mobile phone designed according to the present disclosure;

FIG. 2 illustrates a right view of a mobile phone designed according to the present disclosure;

FIGS. 3a-3d illustrate block diagrams of multiple embodiments of a branch of an antenna efficiency boosting device according to the present disclosure;

FIG. 4 illustrates a block diagram of an antenna efficiency boosting device according to some embodiments of the present disclosure;

FIGS. 5a-5c illustrate actual measurement diagrams of antenna efficiency according to the first embodiment of the present disclosure.

### DETAILED DESCRIPTION

Exemplary embodiments of the present disclosure will be described in more detail below with reference to figures. Although the figures show exemplary embodiments of the present disclosure, it should be appreciated that the present disclosure may be implemented in various forms and should not be limited by embodiments illustrated here. On the contrary, these embodiments are provided to enable more thorough understanding of the present disclosure, and completely convey the scope of the present disclosure to those skilled in the art.

In addition, those skilled in the art should appreciate that figures provided here are all for illustration purpose and the figures are not certainly drawn to a scale.

Meanwhile, it should be appreciated that in the depictions below, “circuit” refers to a conductive loop formed by least one element or sub-circuit being electrically connected or electromagnetically connected. When the element or circuit is “coupled or connected” to another element or the element/circuit is “connected” between two nodes, it may be directly coupled or connected to another element or connected via an intermediate element, connection between elements may be physical, logical or a combination thereof. On the contrary, when the element is “directly coupled to” or directly connected to” another element, this means that there is not an intermediate element between the two elements.

Unless otherwise definitely required in the context, words “comprise” and “include” in the whole description and claims should be interpreted as including rather than excluding or exhausting, namely, “including but not limited to”.

In the depictions in the present disclosure, it needs to be appreciated that terms such as “first” and “second” are only used for descriptive purpose and cannot be understood as indicating or implying relative importance. In addition, unless otherwise specified, “a plurality of” means two or more than two.

The present disclosure relates to an antenna efficiency boosting device for use in a mobile terminal. The mobile terminal is for example a mobile phone, a flat panel computer, wearable apparatus or the like. The mobile terminal has a metallic housing, the metallic housing has at least one discontinuous position (e.g., broken point, broken seam or broken slot),and the antenna efficiency boosting device comprises at least one branch which is coupled to both ends of the discontinuous position for adjusting the efficiency of the antenna of the mobile terminal. The present disclosure will be described below based on embodiments, but the present disclosure is not only limited to these embodiments.

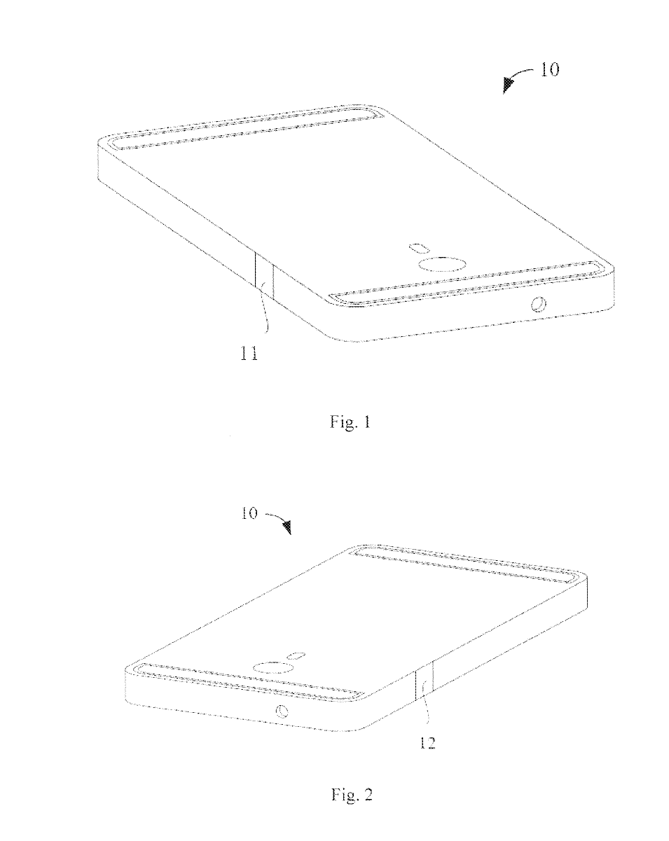

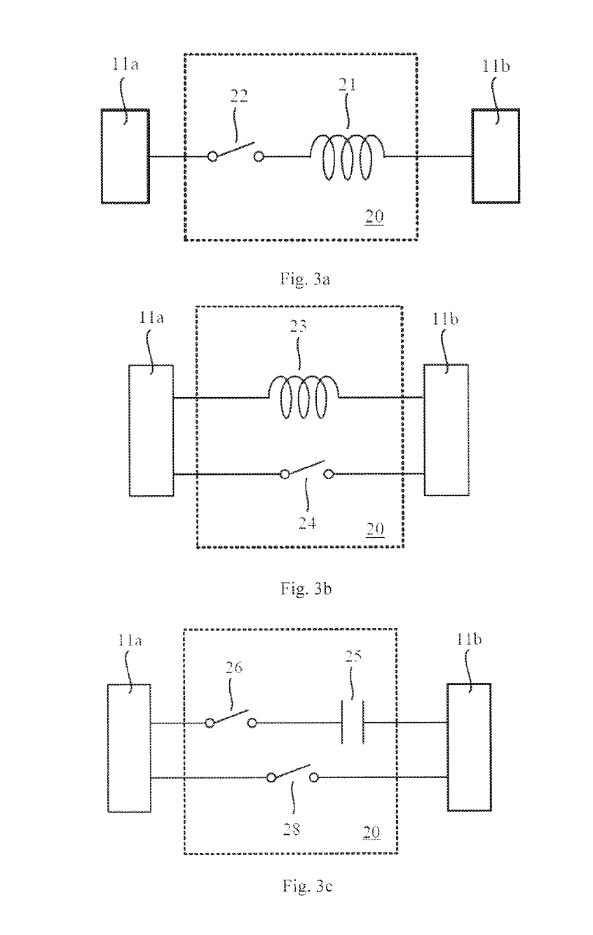

Referring to FIG. 1 and FIG. 2, the mobile phone 10 has a metallic housing, a broken seam 11 is provided on a left frame of the metallic housing, and a broken frame 12 is provided on a right frame of the metallic housing. In another embodiment, the seam 11 is located on a lower frame of the metallic housing, and the seam 12 is located on an upper frame of the metallic housing. It should be appreciated that the positions of the seams are not limited to the above two cases.

The mobile phone 10 comprises an antenna system which is disposed in the metallic housing.

The antenna efficiency boosting device according to the present disclosure comprises at least one branch which is coupled to both ends of a broken seam for adjusting the efficiency of the antenna of the mobile terminal. For example, the antenna efficiency boosting device comprises at least one branch which is coupled to both ends of the broken seam 11, or the antenna efficiency boosting device comprises two branches which are respectively coupled to both ends of the broken seam 11 and both ends of the broken seam 12.

The branch comprises at least one of a switch, an inductor or a capacitor. For example, the branch may be an inductor or a capacitor, or the branch may also be a switch and an inductor (a capacitor) which are connected in series or in parallel. Preferably, the inductor and the capacitor are adjustable devices, namely, the inductor is an inductor whose inductance value is adjustable, and the capacitor is a capacitor whose capacitance value is adjustable.

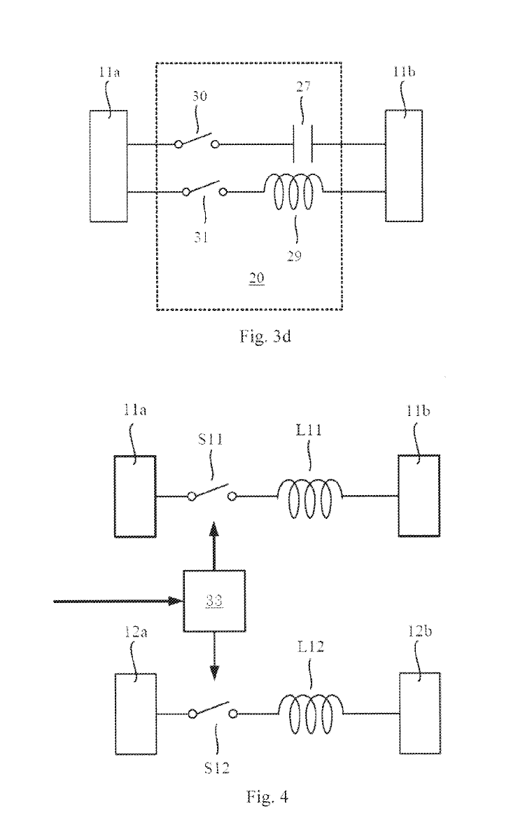

The branch comprises many forms. FIGS. 3a-3d illustrate block diagrams of multiple embodiments of the branch of the antenna efficiency boosting device according to the present disclosure.

Referring to FIG. 3a, the branch 20 comprises an inductor 21 and a switch 22. The inductor 21 and switch 22 are connected in series between a first end 11a and a second end 11b of the broken seam 11.

Referring to FIG. 3b, the branch 20 comprises an inductor 23 and a switch 24. The inductor 23 and switch 24 are connected in series between a first end 11a and a second end 11b of the broken seam 11.

Referring to FIG. 3c, the branch 20 comprises a capacitor 25, a switch 26 and a switch 28. The switch 26 and the capacitor 25 are connected in series between the first end 11a and the second end 11b of the broken seam 11. The switch 28 is coupled between the first end 11a and the second end 11b of the broken seam 11. The switch 26 and the capacitor 25 form a first branch, the switch 28 forms a second branch, and the first branch and the second branch are connected in parallel.

Referring to FIG. 3d, the branch 20 comprises a switch 30, a switch 31, a capacitor 27 and an inductor 29. The switch 30 and the capacitor 27 are connected in series between the first end 11a and the second end 11b of the broken seam 11 to form a first branch. The switch 31 and the inductor 29 are connected in series between the first end 11a and the second end 11b of the broken seam 11 to form a second branch. The first branch and the second branch are connected in parallel. It should be appreciated that the branch of the antenna efficiency boosting device according to the present disclosure is not limited to the above embodiments.

In the case that the shape, structure, layout and antenna form of the mobile terminal are certain, those skilled in the art may determine and optimize the number of branches, the number and connection relationship of the switch, inductor and capacitor, ON/OFF state of the switch by means of simulation or experiments.

In another embodiment, the antenna efficiency boosting device comprises a first branch and a second branch. The first branch is coupled to both ends of the broken seam 11, and the second branch is coupled to both ends of the broken seam 12. The first branch comprises a first switch and a first unit connected in series at both ends of the broken seam 11, and the second branch comprises a second switch and a second unit connected in series at both ends of the broken seam 12, wherein the first unit and the second unit are respectively a circuit formed by at least one of the inductor or the capacitor.

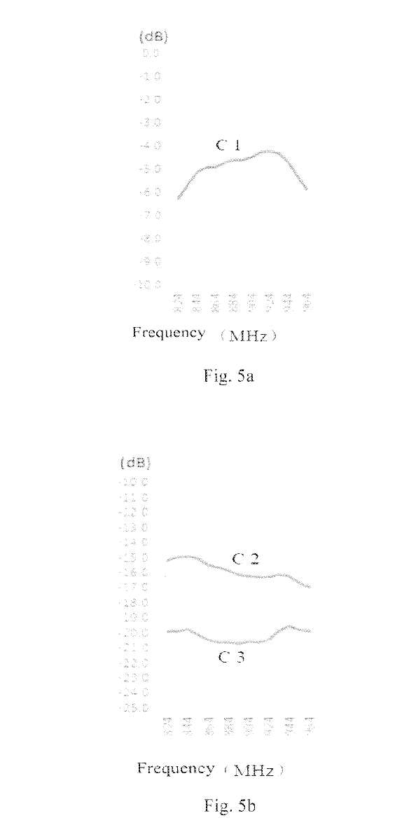

FIG. 4 illustrates a block diagram of an antenna efficiency boosting device according to some embodiments of the present disclosure. The antenna efficiency boosting device comprises a first branch and a second branch.

The first branch is disposed at both ends of the broken seam 11, the first branch comprises a switch S11 and an inductor L11 connected in series between the first end 11a and second end 11b of the broken seam 11, and a value of the inductor L11 is 33 nH. The second branch is disposed at both ends of the broken seam 12, the second branch comprises a switch S12 and an inductor L12 connected in series between the first end 12a and second end 12b of the broken seam 12, and a value of the inductor L12 is 15 nH. The switch S11 and the switch S12 are opened or closed under control of a control unit 23.

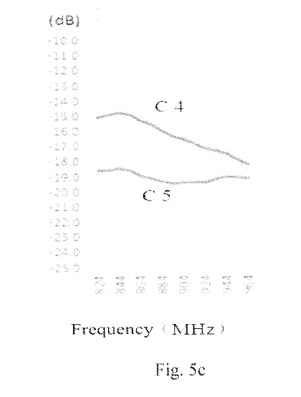

FIGS. 5a-5c illustrate actual measurement diagrams of antenna efficiency according to the second embodiment of the present disclosure. Take a low frequency as an example. When the switch S11 and switch S12 are opened, an actual measurement curve of the antenna efficiency under a free space is C1, and the antenna efficiency is −4.2 dB to −6.2 dB.

In a right-head and hand-held mode, namely, when the user holds the mobile phone with a hand and puts it close to the user's right ear, when the switch S11 and the switch S12 are both opened, an actual measurement curve of the antenna efficiency is C3; when the switch S12 is closed and the switch S11 is opened, an actual measurement curve of the antenna efficiency is C2. Referring to FIG. 5b, the antenna efficiency boosting device of the present disclosure enables the antenna efficiency to rise by 0.9 dB-3.6 dB.

In a left-head and hand-held mode, namely, when the user holds the mobile phone with a hand and puts it close to the user's left ear, when the switch S11 and the switch S12 are both opened, an actual measurement curve of the antenna efficiency is C5; when the switch S11 is closed and the switch S12 is opened, an actual measurement curve of the antenna efficiency is C4.

The antenna efficiency boosting device of the present disclosure enables the antenna efficiency to rise by 0.9 dB-3.6 dB.

In some embodiments, a baseband chip of the mobile terminal receives a strength signal of the antenna (received signal strength indicator RSSI), and the baseband chip judges to select a primary antenna or a secondary antenna according to the strength signal. When the primary antenna is selected, the switch of the branch on the side of the primary antenna is closed; when the secondary antenna is selected, the switch on the side of the secondary antenna is closed. Alternatively, the opening and closing of the switch is controlled and values of the inductance and/or capacitance are controlled by a duly-designed memory table or adaptive algorithm, to allow the antenna efficiency to rise.

The present disclosure further proposes a mobile terminal comprising the antenna efficiency boosting device as stated in the above embodiments.

What are described above are only preferred embodiments of the present disclosure, and not intended to limit the present disclosure. Those skilled in the art appreciate that the present disclosure may have various modifications and variations. Any modifications, equivalent substitutes and improvements within the spirit and principles of the present disclosure all fall within the protection scope of the present disclosure.

1-20. (canceled)

21. An antenna efficiency boosting device for use in a mobile terminal, wherein the mobile terminal has a metallic housing, the metallic housing has at least one discontinuous position, the antenna efficiency boosting device comprises at least one branch which is coupled to both ends of the discontinuous position for adjusting the efficiency of the antenna of the mobile terminal.

22. The antenna efficiency boosting device according to claim 21, wherein the discontinuous position is a broken point, broken slot or broken seam.

23. The antenna efficiency boosting device according to claim 21, wherein said one branch comprises at least one of an inductor, a capacitor or a switch.

24. The antenna efficiency boosting device according to claim 23, wherein the inductor and the capacitor are respectively an adjustable device.

25. The antenna efficiency boosting device according to claim 24, wherein the mobile terminal has a first broken seam and a second broken seam, the antenna efficiency boosting device comprises a first branch and a second branch, the first branch is coupled to both ends of the first broken seam, and the second branch is coupled to both ends of the second broken seam.

26. The antenna efficiency boosting device according to claim 25, wherein the first branch comprises a first switch and a first unit connected in series with the first switch, and the second branch comprises a second switch and a second unit connected in series with the second switch, wherein the first unit and the second unit are respectively a circuit formed by at least one of the inductor or the capacitor.

27. The antenna efficiency boosting device according to claim 26, wherein the antenna efficiency boosting device further comprise a control unit, the control unit is configured to control logic state of the first switch and the second switch, and the logic state comprises closed and opened.

28. The antenna efficiency boosting device according to claim 25, wherein the first broken seam and the second broken seam are respectively disposed on a left frame and a right frame of the metallic housing.

29. The antenna efficiency boosting device according to claim 25, wherein the first broken seam and the second broken seam are respectively disposed on an upper frame and a lower frame of the metallic housing.

30. The antenna efficiency boosting device according to claim 26, wherein the first unit comprises a first inductor and the second unit comprises a second inductor.

31. A mobile terminal, wherein the mobile terminal has a metallic housing, the metallic housing has at least one discontinuous position, the mobile terminal further comprises: an antenna and an antenna efficiency boosting device; the antenna efficiency boosting device comprises at least one branch which is coupled to both ends of the discontinuous position for adjusting the efficiency of the antenna of the mobile terminal.

32. The mobile terminal according to claim 31, wherein the discontinuous position is a broken point, broken slot or broken seam.

33. The mobile terminal according to claim 31, wherein said one branch comprises at least one of an inductor, a capacitor or a switch.

34. The mobile terminal according to claim 33, wherein the inductor and the capacitor are respectively an adjustable device.

35. The mobile terminal according to claim 34, wherein the mobile terminal has a first broken seam and a second broken seam, the antenna efficiency boosting device comprises a first branch and a second branch, the first branch is coupled to both ends of the first broken seam, and the second branch is coupled to both ends of the second broken seam.

36. The mobile terminal according to claim 35, wherein the first branch comprises a first switch and a first unit connected in series with the first switch, and the second branch comprises a second switch and a second unit connected in series with the second switch, wherein the first unit and the second unit are respectively a circuit formed by at least one of the inductor or the capacitor.

37. The mobile terminal according to claim 36, wherein the antenna efficiency boosting device further comprise a control unit, the control unit is configured to control logic state of the first switch and the second switch, and the logic state comprises closed and opened.

38. The mobile terminal according to claim 35, wherein the first broken seam and the second broken seam are respectively disposed on a left frame and a right frame of the metallic housing.

39. The mobile terminal according to claim 35, wherein the first broken seam and the second broken seam are respectively disposed on an upper frame and a lower frame of the metallic housing.

40. The mobile terminal according to claim 36, wherein the first unit comprises a first inductor and the second unit comprises a second inductor.
